(19) United States
(12) Patent Application Publication
(10) Pub. No.: US 2012/0158208 A1
(43) Pub. Date: Jun. 21, 2012

(54) INVERTED PENDULUM TYPE MOVING BODY

(75) Inventors: Tomohiro Kawamoto, Saitama (JP); Ya-chun Chang, Saitama (JP)

(73) Assignee: BOSCH CORPORATION, Tokyo (JP)

(21) Appl. No.: 13/313,103

(22) Filed: Dec. 7, 2011

(30) Foreign Application Priority Data
Dec. 17, 2010 (JP) 2010-282044

(51) Int. Cl. G05D 1/00

(52) U.S. Cl. 701/1

(57) ABSTRACT

An inverted pendulum type moving body. The inverted pendulum type moving body includes: a vehicle body having a riding part on which a rider rides; a rotary body which is rotatably supported on the vehicle body; a rotary body drive unit which rotatably drives the rotary body; and a control device which controls the rotary body drive unit for allowing the inverted pendulum type moving body to travel in accordance with a traveling instruction while keeping a balance, wherein the inverted pendulum type moving body further includes an uncontrollable state detection unit for detecting a state where the control of the inverted pendulum type moving body by the rider is highly improbable, and the control device stops a traveling of the inverted pendulum type moving body when the uncontrollable state is detected based on information detected by the uncontrollable state detection unit.

### BACKGROUND OF THE INVENTION

The present invention relates to an inverted pendulum type moving body which is subject to a traveling control while keeping a balance in accordance with a traveling instruction.

Conventionally, there has been known an inverted pendulum type moving body where an unstable vehicle which is liable to overturn is configured to travel in a stable manner while keeping a balance. As one mode of this inverted pendulum type moving body, there has been known a coaxial two-wheeled vehicle which includes a pair of wheels arranged on the same axis, for example. The coaxial two-wheeled vehicle can travel while keeping a balance of a vehicle body by controlling outputs of electrically-operated motors for rotatably driving the pair of wheels based on a traveling instruction from a control stick which is manipulated by a rider and a weight shift of the rider.

In such a coaxial two-wheeled vehicle, a traveling control is executed by combining a translation motion control which follows a traveling target value for forward traveling or backward traveling generated based on a traveling instruction from a control stick and a weight shift of a rider and an inversion control where a feedback control or a robust control is performed so as to prevent the overturn of an unstable vehicle. (see JP-A-63-305082 and JPA-2004-295430, for example).

The inverted pendulum type moving body has an invertible angle range where the inverted pendulum type moving body is controllable. The invertible angle range means a range where the inclination of a vehicle body with respect to a horizontal surface falls within □10 degrees, for example. Accordingly, when an inclination angle of the inverted pendulum type moving body exceeds the invertible angle range due to a reckless manipulation by a rider for some reason or other, by bumping of the inverted pendulum type moving body into a person or an obstacle or by any disturbance given to the inverted pendulum type moving body from a rough road surface, there exists a possibility that an inversion control of the inverted pendulum type moving body becomes difficult whereby the rider falls from the inverted pendulum type moving body or the inverted pendulum type moving body overturns thus giving rise to a state where the rider cannot manipulate the inverted pendulum type moving body.

In such a case, it is often the case where it is difficult to cut a power source of the inverted pendulum type moving body by manipulating a main switch or a kill switch and hence, there exists a high possibility that a traveling control of the inverted pendulum type moving body is continued in a state where the rider falls or in a state where the inverted pendulum type moving body overturns. As a result, the inverted pendulum type moving body is brought into an unexpected traveling state in spite of the fact that the control of the inverted pendulum type moving body by the rider is highly improbable and hence, there exists a possibility that the moving body injures or damages the rider, pedestrians around the inverted pendulum type moving body, objects present around the inverted pendulum type moving body or the like.

In view of the above-mentioned drawbacks, the inventors of the present invention have found that it is possible to overcome the above-mentioned drawbacks by constituting an inverted pendulum type moving body such that traveling of the inverted pendulum type moving body is forcibly stopped when a state where the control of the inverted pendulum type moving body by a rider is highly improbable is detected, and the inventors have arrived at the present invention.

Accordingly, it is an object of the present invention to provide an inverted pendulum type moving body where reckless traveling of the inverted pendulum type moving body can be prevented when the inverted pendulum type moving body is brought into a state where the control of the inverted pendulum type moving body by the rider is highly improbable.

### SUMMARY OF THE INVENTION

According to one aspect of the present invention, there is provided an inverted pendulum type moving body which includes: a vehicle body having a riding part on which a rider rides; a rotary body which is rotatably supported on the vehicle body; a rotary body drive unit which rotatably drives the rotary body; and a control device which controls the rotary body drive unit for allowing the inverted pendulum type moving body to travel in accordance with a traveling instruction while keeping a balance, wherein the inverted pendulum type moving body further includes an uncontrollable state detection unit for detecting an uncontrollable state where the control of the inverted pendulum type moving body by the rider is highly improbable, and the control device stops a traveling of the inverted pendulum type moving body when the uncontrollable state is detected based on information detected by the uncontrollable state detection unit. Due to such a constitution, the present invention can overcome the above-mentioned drawbacks.

That is, the inverted pendulum type moving body of the present invention is configured such that traveling of the inverted pendulum type moving body is forcibly stopped when a state where the control of the inverted pendulum type moving body by the rider is highly improbable is detected. Due to such a constitution, there exists no possibility that the inverted pendulum type moving body travels recklessly when the moving body is brought into a state where the control of the inverted pendulum type moving body by the rider is highly improbable. Accordingly, a possibility that the inverted pendulum type moving body injures or damages the rider, pedestrians around the inverted pendulum type moving body, objects present around the inverted pendulum type moving body or the like can be reduced.

Further, in constituting the inverted pendulum type moving body of the present invention, it is preferable that the uncontrollable state detection unit detects falling of the rider using a unit for detecting whether or not the rider is riding on the riding part.

In the present invention, the uncontrollable state detection unit is constituted of the unit for detecting whether or not the rider is riding on the riding part and hence, it is possible to accurately detect an uncontrollable state brought about by the falling of the rider.

Further, in constituting the inverted pendulum type moving body of the present invention, it is preferable that the uncontrollable state detection unit detects falling of the rider by executing calculation where a target rotational speed instructed to the rotary body drive unit and a rotational speed of the rotary body are compared to each other.

In the present invention, the uncontrollable state detection unit is a unit which executes calculation where the target rotational speed of the rotary body and the actual rotational speed of the rotary body are compared to each other and hence, an uncontrollable state brought about by falling of the rider can be estimated without using a special sensor or the like.

Further, in constituting the inverted pendulum type moving body of the present invention, it is preferable that the uncontrollable state detection unit detects overturn of the inverted pendulum type moving body using a unit which detects an inclination angle of the vehicle body.

In the present invention, the uncontrollable state detection unit is a unit which detects overturn of the moving body and hence, it is possible to accurately detect that the inverted pendulum type moving body is brought into a state where the control of the moving body by the rider is highly improbable due to the overturn of the moving body.

Further, in constituting the inverted pendulum type moving body of the present invention, it is preferable that the control device stops traveling of the inverted pendulum type moving body by setting an output of the rotary body drive unit to zero.

In the present invention, the control device forcibly stops the traveling of the inverted pendulum type moving body by setting the output of the rotary body drive unit to zero and hence, the traveling of the inverted pendulum type moving body can be stopped as quickly as possible thus allowing the inverted pendulum type moving body to easily avoid a case where the inverted pendulum type moving body injures or damages persons, obstacles or the like present in the traveling direction.

Further, in constituting the inverted pendulum type moving body of the present invention, it is preferable that the control device sets an output of the rotary body drive unit to zero by gradually decreasing the output.

In the present invention, the control device forcibly stops the traveling of the inverted pendulum type moving body by setting the output of the rotary body drive unit to zero by gradually decreasing the output and hence, it is possible to stop the traveling of the inverted pendulum type moving body as quickly as possible while keeping a balance of the inverted pendulum type moving body whereby injuries or damages caused by overturn of the inverted pendulum type moving body can be reduced.

Further, in constituting the inverted pendulum type moving body of the present invention, it is preferable that the control device stops the traveling of the inverted pendulum type moving body by shutting off a main power source.

In the present invention, the control device forcibly stops the traveling of the inverted pendulum type moving body by shutting off the main power source and hence, it is possible to surely prevent a reckless traveling of the inverted pendulum type moving body when the inverted pendulum type moving body overturns.

### BRIEF DESCRIPTION OF THE DRAWINGS

FIG. 1A and FIG. 1B are a front view and a side view of an inverted pendulum type moving body according to an embodiment of the present invention;

FIG. 2 is a view for explaining a constitutional example of an uncontrollable state detection unit provided to the inverted pendulum type moving body according to the embodiment of the present invention;

FIG. 3 is a block diagram of a control circuit of the inverted pendulum type moving body according to the embodiment of the present invention;

FIG. 4 is a countermeasure table for a method of controlling the inverted pendulum type moving body according to the embodiment of the present invention;

FIG. 5 is a flowchart showing one example of the method of controlling the inverted pendulum type moving body according to the embodiment of the present invention;

FIG. 6 is a flowchart for explaining one example of a traveling control of the inverted pendulum type moving body;

FIG. 7 is a flowchart showing one example of a forced stop control;

FIG. 8A and FIG. 8B are views for explaining a constitutional example of another uncontrollable state detection unit;

FIG. 9 is a view for explaining a constitutional example of still another uncontrollable state detection unit; and

FIG. 10 is a flowchart showing one example of a method of estimating the presence or the non-presence of falling of a rider by arithmetic processing.

### DETAILED DESCRIPTION

Hereinafter, an embodiment of an inverted pendulum type moving body according to the present invention is explained specifically in conjunction with drawings. The embodiment explained hereinafter merely describes one mode of the present invention, and the present invention is not limited to the embodiment and may be optionally changed within the scope of the present invention.

In the respective drawings, parts to which the same symbols are given are indicated as identical parts, and the repeated explanation of these parts is omitted when appropriate.

### 1. Constitution of Inverted Pendulum Type Moving Body

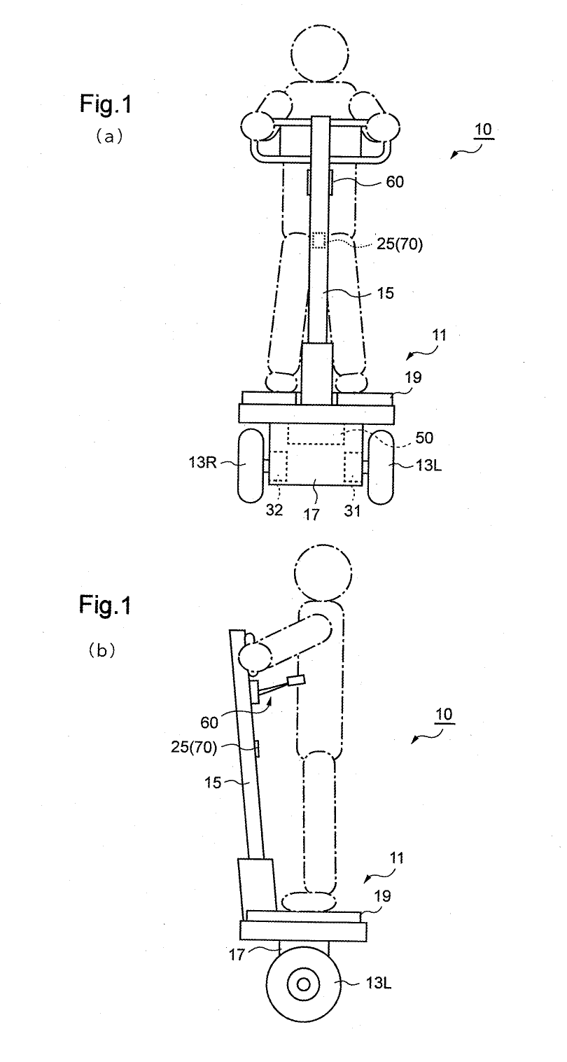

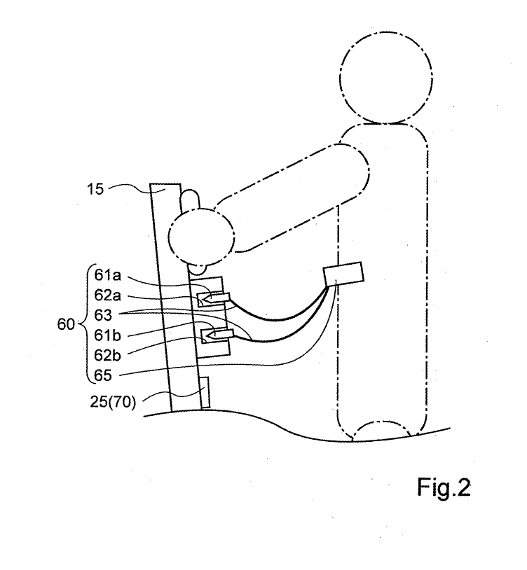

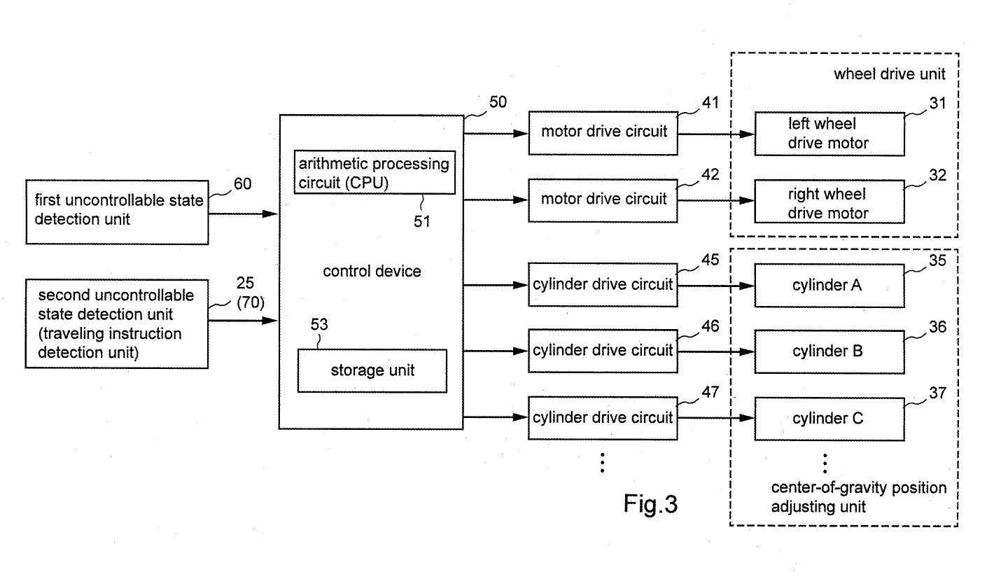

FIG. 1A is a front view of a moving body 10 of this embodiment, and FIG. 1B is a side view of the moving body 10. FIG. 2 is a view showing a constitutional example of a first uncontrollable state detection unit 60 provided to the moving body 10 of this embodiment. Further, FIG. 3 is a block diagram showing a control circuit of the moving body 10 of this embodiment.

The moving body 10 is constituted as a coaxial two-wheeled vehicle which includes a vehicle body 11 having a riding part 19 on which a rider rides, a pair of right and left wheels 13R, 13L which is constituted as a rotary body and a handle 15. The pair of right and left wheels 13R, 13L is arranged on the same axis on both sides of the moving body 10 in the lateral direction orthogonal to the longitudinal direction and, at the same time, is supported on the vehicle body 11 in a rotatable manner relative to the vehicle body 11. The pair of right and left wheels 13R, 13L is connected to a right wheel drive motor 32 and a left wheel drive motor 31 which constitute rotary body drive unit and are housed in a motor box 17.

The moving body 10 includes a traveling instruction detection unit which is used for generating a traveling instruction for the moving body 10 in response to the manipulation by the rider. In the moving body 10 of this embodiment, an inclination angle sensor 25 which detects an inclination angle θ of the handle 15 is used as the traveling instruction detection unit. A control device 50 determines a traveling intention of the rider based on a change of the inclination angle θ and executes a traveling control of the moving body 10. As described later, in the moving body 10 of this embodiment, the inclination angle sensor 25 also functions as a second uncontrollable state detection unit 70.

The inclination angle sensor 25 may be replaced with an inclination angle sensor which detects an inclination angle of the riding part 19, or the inclination angle sensor 25 may be formed using a gyro sensor in place of the inclination angle sensor. Further, the inclination angle sensor 25 may be formed using a sensor which detects a center-of-gravity position of the rider. Further, to explain only a function of detecting a traveling instruction, by using a control stick which is manipulated by the rider as a traveling instruction detection unit, a traveling control of the moving body 10 may be executed based on a manipulation signal from the control stick.

Further, as an uncontrollable state detection unit for detecting a state where the control of the moving body 10 by the rider is highly improbable, the moving body 10 includes the first uncontrollable state detection unit 60 and the second uncontrollable state detection unit 70. Out of these uncontrollable state detection units, the first uncontrollable state detection unit 60 is a unit for detecting the presence or the non-presence of the rider on the riding part 19 and is mainly used for detecting a state where the control of the moving body 10 by the rider is highly improbable when the moving body 10 per se is not in an overturned state. The second uncontrollable state detection unit 70 is mainly used for detecting a state where the control of the moving body 10 by the rider is highly improbable by detecting overturn of the moving body 10.

In the moving body 10 of this embodiment, as shown in FIG. 2, the first uncontrollable state detection unit 60 is constituted of connector pins 61a, 61b, sockets 62a, 62b, pin cords 63, and a connection unit 65. The first uncontrollable state detection unit 60 is used in a state where the rider connects the connection unit 65 to his body during riding. During a period where two connector pins 61a, 61b are respectively inserted into the sockets 62a, 62b, the first uncontrollable state detection unit 60 is energized. On the other hand, when at least one of two connector pins 61a, 61b is removed from the socket 62a, 62b, the first uncontrollable state detection unit 60 is deenergized. Accordingly, the control device 50 can detect the falling of the rider by distinguishing an energized state and a deenergized state from each other.

Further, the second uncontrollable state detection unit 70 is constituted of the inclination angle sensor 25 which also has a function of the traveling instruction detection unit. The control device 50 can estimate overturn of the moving body 10 by determining whether or not the inclination angle θ of the handle 15 which is detected by the inclination angle sensor 25 is outside an invertible angle range.

The control device 50 includes, for example, an arithmetic processing circuit 51 having a microcomputer (CPU), a storage unit 53 having a program memory, a data memory and other RAMs and ROMs and the like. The control device 50 can receive a detection signal transmitted from the first uncontrollable state detection unit 60 and a detection signal transmitted from the inclination angle sensor 25 which constitutes both the traveling instruction detection unit and the second uncontrollable state detection unit 70. Further, to the control device 50, motor drive circuits 41, 42 which respectively drive the left wheel drive motor 31 and the right wheel drive motor 32, and cylinder drive circuits 45, 46, 47, . . . which drive a cylinder A35, a cylinder B36, a cylinder C37, . . . respectively for adjusting inclination angles of the riding part 19 are connected.

The motor drive circuits 41, 42 control the rotational speed, the rotational direction and the like of the pair of wheels 13L, 13R individually, and the left wheel drive motor 31 and the right wheel drive motor 32 are connected to the motor drive circuits 41, 42 individually. The cylinder drive circuits 45, 46, 47, . . . control the extension and the retraction of the cylinder A35, the cylinder B36, the cylinder C37, . . . individually, and the cylinder A35, the cylinder B36, the cylinder C37, . . . are connected to the cylinder drive circuits 45, 46, 47, . . . individually.

### 2. Method of Controlling Inverted Pendulum Type Moving Body

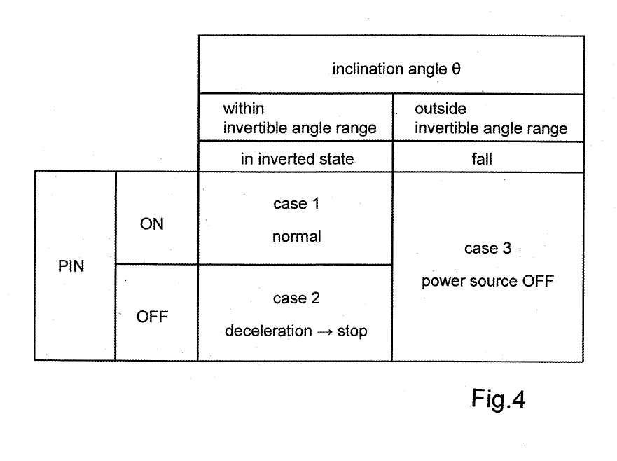

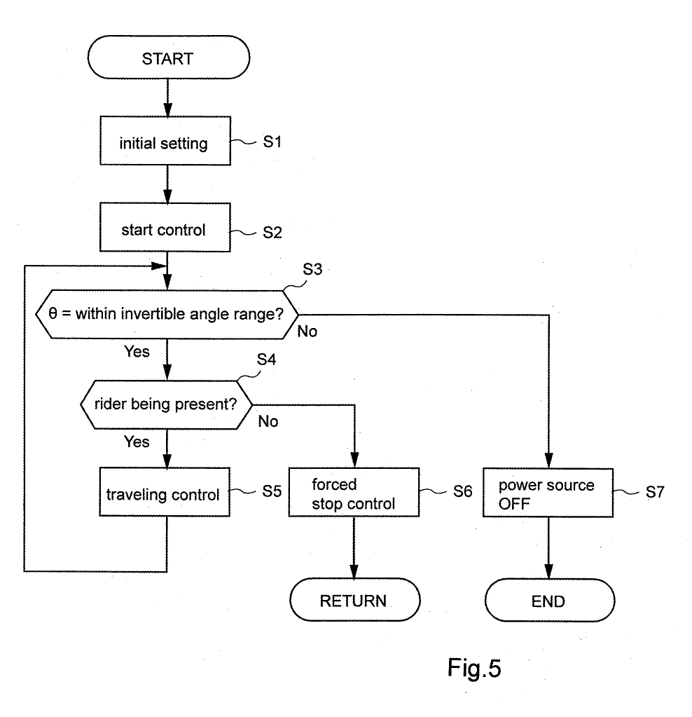

Next, a method of controlling the inverted pendulum type moving body 10 of this embodiment which is executed by the control device 50 is explained in conjunction with a countermeasure table shown in FIG. 4 and flowcharts shown in FIG. 5 to FIG. 7.

Firstly, the countermeasure (control) to be taken by the control device 50 corresponding to detection results of the first uncontrollable state detection unit 60 and the second uncontrollable state detection unit 70 is explained in conjunction with FIG. 4.

FIG. 4 is a table showing detection results of the first uncontrollable state detection unit 60 and the second uncontrollable state detection unit 70 with respect to the moving body 10 of this embodiment, and the countermeasure (control) to be taken by the control device 50 corresponding to the respective detection results.

The control device 50 recognizes that the rider is riding on the moving body when the connector pins 61a, 61b which constitute the first uncontrollable state detection unit 60 are inserted into the sockets 62a, 62b respectively (=PIN: ON), while the control device 50 recognizes that the rider falls from the moving body when the connector pins 61a, 61b are disconnected from the sockets 62a, 62b (=PIN: OFF).

Further, the control device 50 recognizes that the moving body 10 is in an inverted state when the inclination angle θ detected by the inclination angle sensor 25 which constitutes the second uncontrollable state detection unit 70 is within the invertible angle range, while the control device 50 recognizes that the moving body 10 is in an overturned state when the inclination angle θ is outside the invertible angle range.

At a point of time that initial setting is completed and the connector pins 61a, 61b are inserted into the sockets 62a, 62b by the rider, it is recognized that the moving body 10 is in a normal state (CASE 1).

Thereafter, the rider rides on the moving body 10. After the traveling control is started, so long as the connector pins 61a, 61b are inserted (PIN: ON) and the inclination angle θ is within the invertible angle range, it is recognized that the moving body 10 is in a normal state (CASE 1) so that the control device 50 executes a usual traveling control.

On the other hand, when the inclination angle θ becomes outside the invertible angle range after the traveling control is started, it is recognized that the moving body 10 is in an overturned state (CASE 3), and the control device 50 forcibly shuts off a main power source of the moving body 10 irrespective of the presence and the non-presence of the rider, that is, a state of the connector pins 61a, 61b (PIN:ON or PIN:OFF).

Further, even when the inclination angle θ is within the invertible angle range, when the connector pins 61a, 61b are disconnected (PIN:OFF), it is recognized that the rider falls while the moving body 10 is kept in an inverted state (CASE 2), and the control device 50 forcibly stops the traveling of the moving body 10 by decelerating the moving body 10.

The control executed by the control device 50 as described above is explained in conjunction with a flowchart. Firstly, in step Si in FIG. 5, the control device 50 performs initial setting of the system. To be more specific, in this step S1, the completion of setting of the first uncontrollable state detection unit 60 is confirmed or a detection value of the inclination angel sensor 25 when the vehicle body 11 is in a horizontal state is set to a default. For example, when the power source of the moving body 10 is turned on, the control device 50 determines whether or not the first uncontrollable state detection unit 60 is in an energized state due to the insertion of the connector pins 61a, 61b into the sockets 62a, 62b. Further, an inclination angle θ currently detected in a state where the vehicle body 11 is in a horizontal state before the rider rides on the riding part 19 and after an initial setting button is pushed by the rider is set to a reference angle θ0.

Next, the control device 50 starts a translation traveling control and an inversion control of the moving body 10 in step S2. For example, the control device 50 starts the translation traveling control and the inversion control in response to the determination that the moving body 10 is in a riding ready state. Simultaneously with such processing, the control device 50 outputs a signal which allows a control panel or the like to display a riding ready state. Thereafter, the rider rides on the vehicle body 11, and an operation of the moving body 10 is started by the rider.

Here, timing at which the translation traveling control and the inversion control are started and timing at which a display of a riding ready state is performed are not limited to the above-mentioned example. For example, a display of a riding ready state may be performed at the time of completion of the above-mentioned step S1. The translation traveling control and the inversion control may be started in response to pushing of a control start button by the rider or the like.

Next, in step S3, it is determined whether or not the inclination angle θ detected by the inclination angle sensor 25 which constitutes the second uncontrollable state detection unit 70 is within the invertible angle range. For example, the determination is made based on whether or not a detected inclination angle θ is within a range of reference angle θ0±10°. When it is determined that the inclination angle θ is outside the invertible angle range, the control device 50 determines that the moving body 10 is in an overturned state, and the control device 50 forcibly shuts off the power source so as to prevent reckless traveling of the moving body 10. In this case, when the power source is turned on next, the processing starts again from initial setting in step S1.

On the other hand, when it is determined that the inclination angle θ is within the invertible angle range in step S3, the control device 50 determines whether or not the rider falls from the vehicle body 11 in next step S4. In the example of the moving body 10 of this embodiment, in step S4, the control device 50 determines the presence or the non-presence of the rider based on whether the first uncontrollable state detection unit 60 is in an energized state or a deenergized state. When the first uncontrollable state detection unit 60 is in an energized state, it is determined that the rider is present on the vehicle body 11 and hence, the control device 50 makes the affirmative determination so that processing advances to step S5 where a traveling control is executed.

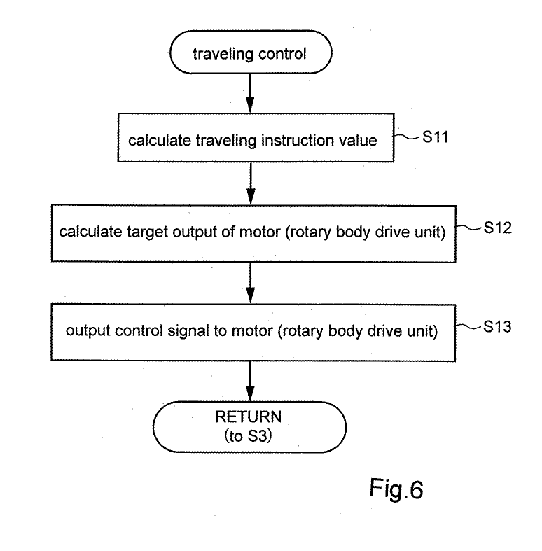

FIG. 6 shows one example of a specific flow of the traveling control. In this example of the traveling control, firstly, in step S11, the control device 50 detects a traveling instruction value based on a detection signal from the inclination angle sensor 25 which constitutes the traveling instruction detection unit. In the moving body 10 of this embodiment which uses the inclination angle sensor 25 as the traveling instruction detection unit, a traveling instruction value of the moving body 10 is calculated by arithmetic processing based on a detected inclination angle of the handle 15. The traveling instruction value is obtained as values which include the turning direction and the acceleration of the moving body 10.

After the traveling instruction value is obtained, the control device 50 obtains target outputs of the left wheel drive motor 31 and the right wheel drive motor 32 which drive the pair of wheels 13L, 13R by arithmetic processing in step S12. For example, the control device 50 calculates the target outputs based on map information stored in the storage unit 53 of the control device 50 in advance. Here, the target outputs may be calculated by taking into account not only an inclination angle but also an increase or decrease amount of the inclination angle (inclination angular velocity) per unit time.

Next, in step S13, the target outputs of the left wheel drive motor 31 and the right wheel drive motor 32 obtained in step S12 are converted into control signals indicative of electric current values, and the control signals are outputted to the motor drive circuits 41, 42. As a result, the pair of wheels 13L, 13R is rotatably driven by the left wheel drive motor 31 and the right wheel drive motor 32 respectively thus realizing a traveling state in response to a traveling instruction based on intention of the rider. After the outputting of the control signals to the motor drive circuits 41, 42 is finished, processing returns to step S3 again.

On the other hand, in step S4, when the first uncontrollable state detection unit 60 is in a deenergized state, it is determined that the rider is not present on the vehicle body 11 and hence, the control device 50 makes the negative determination so that processing advances to step S6 where a forced stop control is executed.

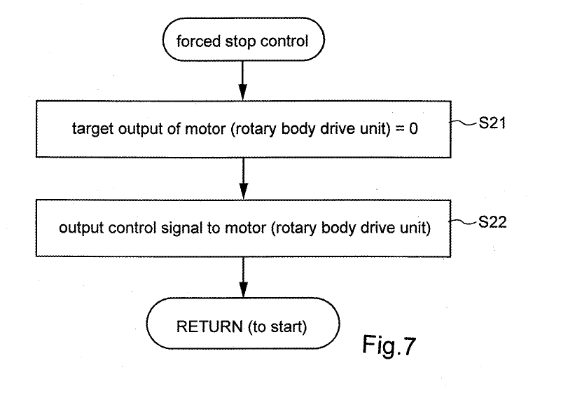

FIG. 7 shows one example of a specific flow of the forced stop control. In an example of this forced stop control, firstly, in step S21, the control device 50 sets target outputs of the left wheel drive motor 31 and the right wheel drive motor 32 to zero. Subsequently, the control device 50 converts the target outputs (=0) of the left wheel drive motor 31 and the right wheel drive motor 32 which are obtained in step S22 into control signals indicative of electric current values, and outputs the control signals to the motor drive circuits 41, 42. As a result, rotational speed of the pair of wheels 13L, 13R approaches 0, and the traveling of the moving body 10 is stopped.

Here, to prevent the overturn of the vehicle body 11 caused by the forced stop of the moving body 10, the target outputs of the left wheel drive motor 31 and the right wheel drive motor 32 may not be set to zero at once but may be gradually led to 0. When a forced stop is performed during turning traveling of the moving body 10, there exists a high possibility that the moving body 10 overturns. Accordingly, it is preferable that a forced stop control is executed while returning the moving body 10 to a straight traveling state in the step of executing the forced stop of the moving body 10. After the traveling of the moving body 10 is decelerated and is stopped, processing returns to step S1 again, and the control device 50 assumes a standby state until the connector pins 61a, 61b are inserted into the sockets 62a, 62b.

According to the above-explained moving body 10 of this embodiment, during traveling of the moving body 10 in a state where a rider is riding on the moving body 10, when the moving body 10 overturns or the rider falls from the moving body 10, the control device 50 detects the overturn of the moving body 10 or the falling of the rider and forcibly stops the traveling of the moving body 10. Accordingly, it is possible to prevent the reckless traveling of the moving body 10 in a state where the control of the moving body by the rider is highly improbable whereby a possibility that the moving body 10 injures or damages the rider, pedestrians around the moving body 10, objects present around the moving body 10 and the like can be reduced.

In the moving body 10 of this embodiment, when the overturn of the moving body 10 is detected by the inclination angle sensor 25 which constitutes the second uncontrollable state detection unit 70, the power source of the moving body 10 is shut off irrespective of the presence or the non-presence of the rider whereby the traveling of the moving body 10 is forcibly stopped. Accordingly, it is possible to surely prevent the reckless traveling of the moving body 10 when the moving body 10 overturns.

Further, in the moving body 10 of this embodiment, the first uncontrollable state detection unit 60 having the mechanical constitution is used as a unit for detecting the falling of the rider and hence, the falling of the rider can be surely detected. Accordingly, even in the case where the moving body 10 is not in an overturned state, the traveling of the moving body 10 is forcibly stopped when the rider falls thus enhancing the effectiveness of the forced stop control.

### 3. Other Embodiments

The moving body 10 of this embodiment is not limited to the above-explained example, and the constitution of the moving body 10 may be modified as follows.

In the above-described example of the moving body 10, the first uncontrollable state detection unit 60 is constituted of the connector pins 61a, 61b, the sockets 62a, 62b and the pin cord 63. However, the specific constitution of the first uncontrollable state detection unit is not limited to such an example.

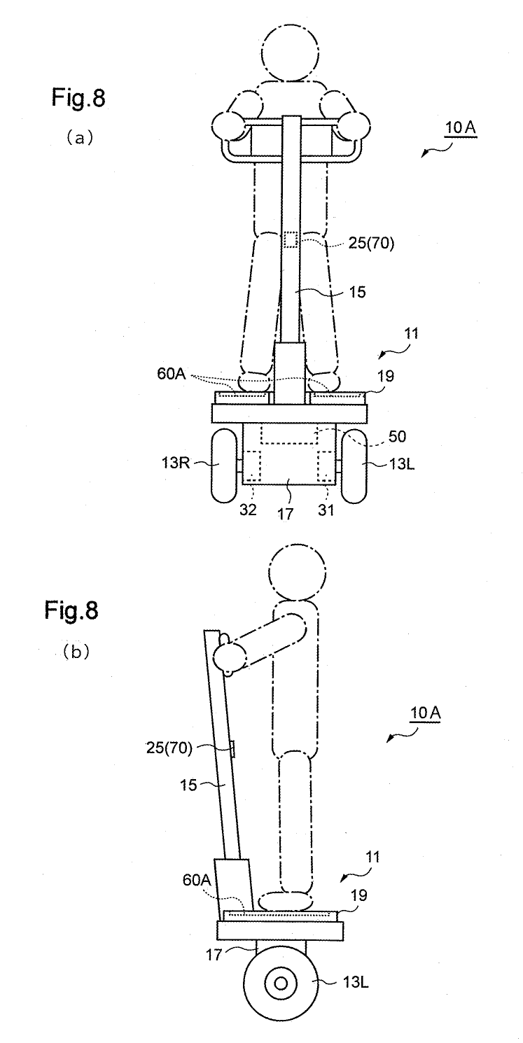

For example, FIG. 8A and FIG. 8B show a moving body 10A which includes, as the first uncontrollable state detection unit, an uncontrollable state detection unit 60A which is constituted of a load sensor mounted on an upper surface or mounted in the inside of the riding part 19. The moving body 10A is configured such that, when a sensor value of the load sensor is rapidly decreased, the control device 50 detects falling of a rider by making use of a fact that a sensor value of the load sensor differs depending on applied pressure. This uncontrollable state detection unit 60A having such a constitution can also surely detect the falling of the rider.

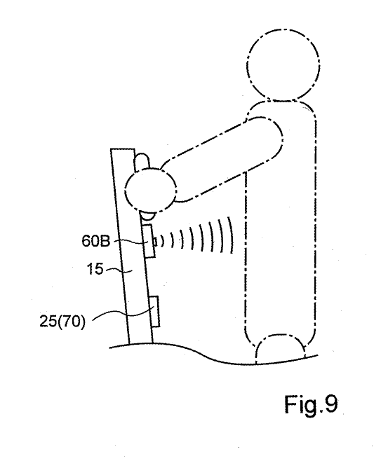

Further, FIG. 9 shows an uncontrollable state detection unit 60B which uses, as the first uncontrollable state detection unit, a sensor having a transceiver which transmits electromagnetic waves or optical waves and receives reflected waves of the electromagnetic waves or the optical waves. As such a sensor, a known sensor such as a pyroelectric sensor, an infrared ray sensor or a sensor which can transmit and receive laser beams, radar beams or millimeter waves can be suitably used. This uncontrollable state detection unit 60B having such a constitution can also surely detect the falling of the rider.

Although not shown in the drawing, the first uncontrollable state detection unit 60 may be constituted such that falling of a rider is detected by an image processing device which uses a camera.

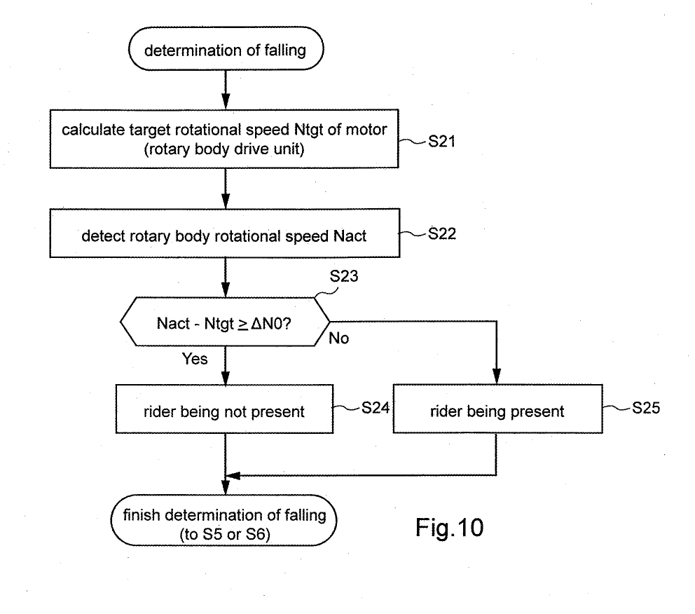

Further, the presence or the non-presence of the falling of a rider may be estimated by arithmetic processing by the control device 50 without using a detection unit having the mechanical constitution such as a sensor. FIG. 10 shows one example of a specific flow of a method for determining the presence or the non-presence of the falling of the rider by arithmetic processing, and this processing is executed in place of the processing in step S4 shown in FIG. 5.

In this flow shown in FIG. 10, in step S21, the control device 50 calculates a target rotational speed Ntgt of at least one of the left wheel drive motor 31 and the right wheel drive motor 32 which constitute the rotary body drive unit. The target rotational speed Ntgt can be obtained based on a target output which is calculated in step S12 in the above-mentioned flowchart shown in FIG. 6, for example.

Next, in step S22, the control device 50 detects an actual rotational speed Nact of the wheel 13L, 13R corresponding to the target rotational speed Ntgt which is calculated in step S21 using a rotational speed sensor or the like mounted on an axle or the like. Then, in step S23, the control device 50 determines whether or not the difference between the actual rotational speed Nact and the target rotational speed Ntgt is a predetermined threshold value □NO or more.

In step S23, the control device 50 determines the presence or the non-presence of falling of the rider by making use of the fact that a load applied to the left wheel drive motor 31 and the right wheel drive motor 32 differs between a case where the rider is riding on the vehicle body 11 and a case where the rider is not riding on the vehicle body 11 so that the actual rotational speed Nact of the wheels 13L, 13R differs from the target rotational speed Ntgt when the motors are controlled with the same output. Although the threshold value □NO is obtained by an experiment or the like in advance and can be stored in the control device 50, the threshold value DNO may be corrected corresponding to a weight of the rider and the like.

When the determination made in step S23 is affirmative, that is, when the difference between an actual rotational speed Nact and the target rotational speed Ntgt is the threshold value DNO or more, processing advances to step S24, and the control device 50 determines that the rider falls from the vehicle body 11 and finishes the determination. On the other hand, when the determination made in step S23 is negative, that is, when the difference between the actual rotational speed Nact and the target rotational speed Ntgt is less than the threshold value DNO, processing advances to step S25, the control device 50 determines that the rider is riding on the vehicle body 11 and finishes the determination.

As described above, by constituting the moving body 10 of the present invention such that the presence or the non-presence of falling of the rider is determined by arithmetic processing executed by the control device 50, it is possible to estimate the falling of the rider without using a special sensor or the like.

Further, in place of the comparison between the target rotational speed Ntgt and the actual rotational speed Nact, the presence or the non-presence of the rider on the moving body 10 may be determined by continually collating target current values of the left wheel drive motor 31 and the right wheel drive motor 32 with the actual behavior (speed, acceleration and the like) of the moving body 10.

Alternatively, the presence or the non-presence of the rider on the moving body 10 may be determined by detecting output torques of the left wheel drive motor 31 and the right wheel drive motor 32 which are momentarily changed by continually detecting target current values of the left wheel drive motor 31 and the right wheel drive motor 32 or values of electric currents of those wheel drives which actually flow and by comparing the obtained output torques with the above-mentioned actual behavior (speed, acceleration and the like) of the moving body 10.

To be more specific, the behavior of the moving body 10 when a certain torque is applied to the moving body 10 can be calculated by an equation of motion, and by comparing the behavior obtained by calculation and the actual behavior, the presence or the non-presence of the rider can be determined. The equation of motion is disclosed in JP-A-63-305082, for example

With respect to the unit for detecting falling of the rider and the unit for detecting overturn of the moving body 10, although the moving body 10 may use only one of these units described heretofore, the moving body 10 may also use a plurality of these units simultaneously. In this case, it may be determined that the falling or the overturn actually occurs when the falling of the rider or the overturn of the moving body is detected by any one of the plurality of units, or it may be determined that the falling and the overturn actually occurs when the falling and the overturn are detected by all of the plurality of units.

Further, in the above-mentioned moving body 10, the traveling control of the moving body 10 is executed in response to a traveling instruction based on an inclination angle of the handle 15 or the riding part 19 or the center-of-gravity position of the rider. However, the present invention is also applicable to a moving body where the traveling control is executed based on a traveling instruction based on communication from the outside or manual inputting by a rider or the like.

Further, also with respect to the mode of the moving body, the present invention is applicable to, besides the coaxial two-wheeled vehicle exemplified in this embodiment, an inverted pendulum type moving body in general such as a moving body which uses a cylindrical one-wheeled rotary body or a moving body which uses a spherical rotary body.

1. An inverted pendulum type moving body comprising:
a vehicle body having a riding part on which a rider rides;
a rotary body which is rotatably supported on the vehicle body;
a rotary body drive unit which rotatably drives the rotary body; and
a control device which controls the rotary body drive unit for allowing the inverted pendulum type moving body to travel in accordance with a traveling instruction while keeping a balance;
wherein the inverted pendulum type moving body further comprises an uncontrollable state detection unit for detecting an uncontrollable state where the control of the inverted pendulum type moving body by the rider is highly improbable, and
the control device stops a traveling of the inverted pendulum type moving body when the uncontrollable state is detected based on information detected by the uncontrollable state detection unit.

2. The inverted pendulum type moving body according to claim 1, wherein the uncontrollable state detection unit detects falling of the rider using a unit for detecting whether or not the rider is riding on the riding part.

3. The inverted pendulum type moving body according to claim 1, wherein the uncontrollable state detection unit detects falling of the rider by comparing a target rotational speed instructed to the rotary body drive unit and a rotational speed of the rotary body.

4. The inverted pendulum type moving body according to claim 1, wherein the uncontrollable state detection unit detects overturn of the inverted pendulum type moving body using a unit which detects an inclination angle of the vehicle body.

5. The inverted pendulum type moving body according to claim 1, wherein the control device stops traveling of the inverted pendulum type moving body by setting an output of the rotary body drive unit to zero.

6. The inverted pendulum type moving body according to claim 5, wherein the control device sets an output of the rotary body drive unit to zero by gradually decreasing the output.

7. The inverted pendulum type moving body according to claim 1, wherein the control device stops traveling of the inverted pendulum type moving body by shutting off a main power source.
